(19) United States
(12) Patent Application Publication
(10) Pub. No.: US 2009/0087611 A1
(43) Pub. Date: Apr. 2, 2009

(54) STEEL SHEET OVERLAP STRUCTURE, METHOD FOR MANUFACTURING SAME, AND STEEL SHEET FOR STEEL SHEET OVERLAP STRUCTURE

(75) Inventors: Noriyuki KURAMOTO, Yonezawa-shi (JP); Yu Takada, Toyota-shi (JP); Masahiko Ishii, Okazaki-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIK KAISHA, Toyota-shi (JP)

(21) Appl. No.: 12/238,825

(22) Filed: Sep. 26, 2008

(30) Foreign Application Priority Data
Sep. 27, 2007 (JP) 2007-252671

(51) Int. Cl. B32B 3/14; C09J 139/00

(52) U.S. Cl. 428/78; 156/330.9

(57) ABSTRACT

A steel sheet overlap structure including a pair of joined steel sheets and an antirust layer which comprises an electrically conductive polymer, and which is provided between joining surfaces of the steel sheets.

### INCORPORATION BY REFERENCE

The disclosure of Japanese Patent Application No. 2007-252671 filed on Sep. 27, 2007, including the specification, drawings and abstract is incorporated herein by reference in its entirety.

### BACKGROUND OF THE INVENTION

1. Field of the Invention

The present invention relates to a steel sheet overlap structure, a method for manufacturing same, and a steel sheet for a steel sheet overlap structure.

2. Description of the Related Art

Steel sheet overlap structures used in bodies of automobiles and home electric appliances are produced by joining by spot welding or the like a plurality of steel sheets machined to a desired shape. Antirust treated steel sheets such as galvanized steel sheets have been widely used as the steel sheets for such structures. However, in order to facilitate welding of the steel sheets, the antirust ability thereof has to be ensured with a thin plated layer, therefore, sufficient antirust performance sometimes cannot be demonstrated.

In particular, the joint portion of steel sheets is a structure where a pair of steel sheets are in contact with each other, and in the conversion film formation or electrodeposition that is usually performed for rust prevention, there are sometimes zones into which the coating film or electrodeposited material do not penetrate. As a result, the joint portion of steel sheets is sometimes not coated and exposed to corrosive environment. To prevent it, an antirust treatment such that uses a body sealer, an undercoat, or a pouch wax is performed.

Further, a variety of antirust materials have been investigated with the object of preventing rust on the joint portions of steel sheets. For example, Japanese Patent Application Publication No. 11-222565 (JP-A-11-222565) describes an example of using an antirust coating material including a petroleum sulfonate, lanolic fatty acid, hardened castor oil, a fatty filler and/or a fiber filler at the joint portion of steel sheets.

The antirust coating material described in JP-A-11-222565 demonstrates excellent antirust performance, but it is still insufficient to prevent the joint portion of steel sheets from rust.

### SUMMARY OF THE INVENTION

It is an object of the present invention to provide a steel sheet overlap structure that can ensure antirust ability in the joint portion of the steel sheets, without performing an antirust treatment with a sealer or the like, a method for manufacturing such a structure, and a steel sheet for the steel sheet overlap structure.

The first aspect of the present invention relates to a steel sheet overlap structure. The steel sheet overlap structure includes a pair of joined steel sheets and an antirust layer which contains an electrically conductive polymer, and which is provided between the steel sheets.

The second aspect of the present invention relates to a steel sheet overlap structure. The steel sheet overlap structure includes a pair of steel sheets joined in a joint portion, and an antirust layer which contains an electrically conductive polymer, and which is provided between a periphery of the joint portion and opposing surfaces of the pair of steel sheets.

The third aspect of the present invention relates to a steel sheet overlap structure. The steel sheet overlap structure includes a pair of joined steel sheets and an antirust layer which contains an electrically conductive polymer, and which is provided at an end surface of the steel sheets.

The fourth aspect of the present invention relates to a steel sheet for a steel sheet overlap structure. The steel sheet is provided with an antirust layer containing an electrically conductive polymer.

The fifth aspect of the present invention relates to a method for manufacturing a steel sheet overlap structure. This manufacturing method includes an antirust treatment process of forming an antirust layer containing an electrically conducive polymer on at least one surface of a pair of steel sheets to be joined, and a joining process of joining the pair of steel sheets via the antirust layer.

The sixth aspect of the present invention relates to a method for manufacturing a steel sheet overlap structure. This manufacturing method includes an antirust treatment process of forming an antirust layer containing an electrically conducive polymer on an end surface of at least one steel sheet of a pair of steel sheets to be joined, and a joining process of joining the pair of steel sheets so that the end surface where the antirust layer has been formed is located in the vicinity of a joining position of the pair of steel sheets.

The above-described aspects of the present invention provide a steel sheet overlap structure that can ensure antirust ability in the joint portion of the steel sheets, without performing an antirust treatment with a sealer or the like, a method for manufacturing such a structure, and a steel sheet for the steel sheet overlap structure.

### BRIEF DESCRIPTION OF THE DRAWINGS

The foregoing and further features and advantages of the present invention will become apparent from the following description of example embodiments with reference to the accompanying drawings, where the like numerals are used to represent like elements, and wherein:

FIG. 1 is a cross-sectional view illustrating a periphery of a joint portion of a steel sheet overlap structure of the first embodiment;

FIG. 2 illustrates a polyaniline coating effect on a potential-current curve of steel (St-37), stainless steel (V2A), and copper;

FIG. 3 is a cross-sectional view illustrating a periphery of a joint portion of a modification example of a steel sheet overlap structure of the first embodiment;

FIG. 4 is a cross-sectional view illustrating a periphery of a joint portion of another modification example of a steel sheet overlap structure of the first embodiment; and

FIG. 5 is a cross-sectional view illustrating a joint portion of a steel sheet overlap structure of the second embodiment.

### DETAILED DESCRIPTION OF EMBODIMENTS

A steel sheet overlap structure and a method for manufacturing same in accordance with the present invention will be described below in greater details with reference to the appended drawings. Components having identical functions will be denoted by identical reference symbols in all the drawings, and redundant explanation thereof will be omitted.

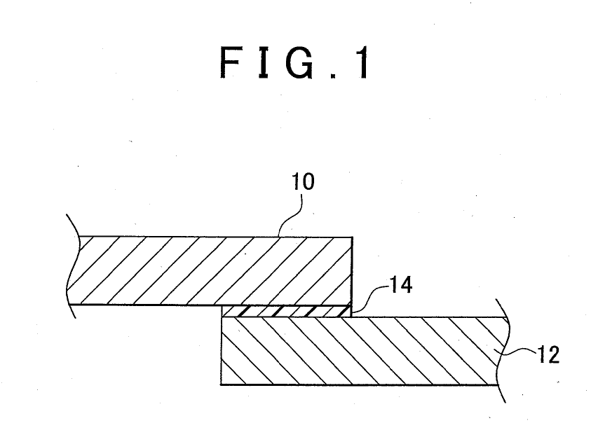

FIG. 1 is a cross-sectional view illustrating a periphery of a joint portion of a steel sheet overlap structure of the first embodiment of the present invention. The steel sheet overlap structure of the first embodiment includes a steel sheet 10, a steel sheet 12 joined thereto, and an antirust layer 14 including an electrically conductive polymer provided between the joining surfaces of the steel sheet 10 and steel sheet 12.

By providing the antirust layer 14 between the steel sheet overlap zone (periphery of joint portion) of the steel sheet 10 and steel sheet 12, it is possible to prevent the occurrence of rust in the joint portion.

Examples of the steel sheet 10 and steel sheet 12 include cold-rolled steel sheets, antirust treated steel sheets such as galvanized steel sheets, stainless steel sheets, and aluminum steel sheets, but among them antirust treated steel sheets are preferred. More specifically, galvanized steel sheets such as electrogalvanized steel sheets, hot-dip galvanized steel sheets, and hot-dip galvanized and alloyed steel sheets are preferred.

The steel sheet 10 and steel sheet 12 are joined, for example, by spot welding. Typical spot welding conditions are a welding current of 3500 to 8800 A, a pressure force of 392 to 1961 N, and the number of conduction cycles of 8 to 69.

The antirust layer 14 includes an electrically conductive polymer. The electrically conductive polymer is not particularly limited provided that the polymer can form a passivation state on the steel sheet surface. Formation of a passivation state on the steel sheet surface inhibits the occurrence of rust. Specific examples of the electrically conductive polymer capable of forming a passivation state on the steel sheet surface include polypyrroles, polythiophenes, polyanilines, poly-p-phenylenes, and polyphenylenevinylene. Among them, polyanilines are preferred.

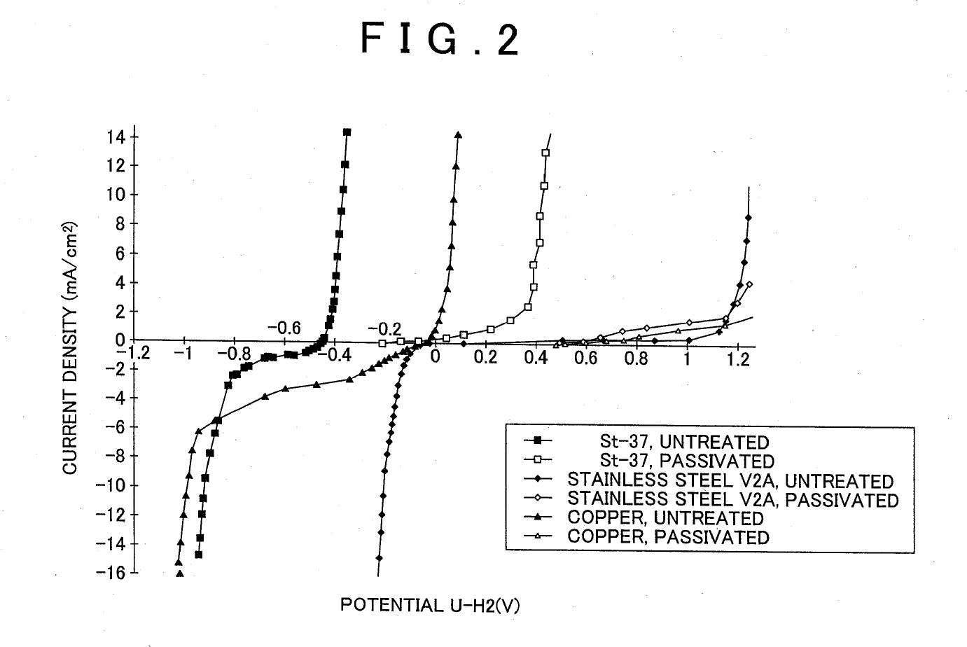

FIG. 2 illustrates a polyaniline coating effect (passivation treatment effect) on a potential-current curve of steel (St-37), stainless steel (V2A), and copper. Coating with a polyaniline clearly shifts the electric potential to a noble side (stable direction). As a result, the metal surface is passivated, and it is clear that coating a metal surface with a polyaniline produces an antirust effect.

The polyaniline used in the present embodiment is preferably a polyaniline doped with a metal phosphate. The polyaniline doped with a metal phosphate will be described below.

The polyaniline doped with a metal phosphate (can be referred to hereinbelow simply as “polyaniline of the present embodiment”) can be manufactured via a process of preparing an aniline mixed solution by adding a surfactant, water, a water-soluble protonic acid, a metal phosphate, and at least one from among aniline and a derivative thereof to an organic solvent immiscible with water (can be referred to hereinbelow as “mixing process”) and a process of adding a polymerization initiator to the aniline mixed solution and polymerizing at least one from among the aniline and a derivative thereof (can be referred to hereinbelow as “polymerization process”).

In the mixing process, an aniline mixed solution is prepared by adding a surfactant, water, a water-soluble protonic acid, a metal phosphate, and at least one from among aniline and a derivative thereof to an organic solvent immiscible with water. In the aniline mixed solution, an aniline salt is formed by the aniline or a derivative thereof and the metal phosphate.

Specific examples of the organic solvent immiscible with water that is used in the mixing process include benzene, toluene, chloroform, and xylene. The preferred among them are toluene and xylene. In the present embodiment, “the organic solvent immiscible with water” is an organic solvent with a solubility parameter (SP value) of about 7 to 12.

The surfactant used in the mixing process is not particularly limited, and an anionic surfactant, a cationic surfactant, and a nonionic surfactant can be used. Examples of cationic surfactants include long-chain alkyl ammonium salts and quaternary ammonium salts, cethyltrimethylammonium bromide being a specific example. Examples of anionic surfactants include long-chain alkyl sulfates, carboxylic acid salts, and sulfuric acid ester salts. Specific examples include sodium dodecylsulfate and alkyl sulfuric acid ester salts. Examples of nonionic surfactants include fatty acids and higher alcohols. Specific examples include glycerin fatty acid esters and polyoxyethylene alkyl ethers.

Among them, anionic surfactants are preferably used because a salt is formed by an aniln and the surfactant and the polymerization is further performed under micelle formation.

Specific examples of the water-soluble protonic acid used in the mixing process include phosphoric acid, hydrochloric acid, sulfuric acid, and nitric acid. Among them, phosphoric acid is preferred from the standpoint of ability to impart a function of a buffer liquid to the solution including a polyaniline of the present embodiment due to the co-presence of a metal phosphate.

Specific examples of the metal phosphate used in the mixing process include zinc phosphate, iron phosphate, and manganese phosphate. Among them, zinc phosphate is preferred because it has excellent antirust ability.

Specific examples of at least one from among aniline and a derivative thereof that is used in the mixing process include aniline and anisidine, but aniline is preferred because it is easy to acquire. In the present embodiment, aniline and a derivative thereof can be used in a mixture of two or more thereof.

The order of adding the surfactant, water, water-soluble protonic acid, metal phosphate, and at least one from among aniline and a derivative thereof to the organic solvent immiscible with water in the mixing process is not particularly limited.

In the polymerization process, a polymerization initiator is added to the aniline mixed solution prepared in the mixing process and the at least one from among aniline and a derivative thereof is polymerized. A polyaniline is synthesized by the polymerization reaction.

The polymerization initiator used in the polymerization process is not particularly limited provided that the aniline and derivative thereof can be polymerized. Examples of suitable polymerization initiators include ammonium persulfate, hydrogen peroxide, and ferric chloride. These polymerization initiators can be used individually or in combinations of two or more thereof. Among them, ammonium persulfate is preferred as the polymerization initiator.

The polymerization temperature and polymerization time in the polymerization process can be appropriately adjusted based on the type and amount added of the aniline and a derivative thereof and also the polymerization initiator.

The antirust layer 14 may include, if necessary a matrix resin and an antirust additive in addition to the above-described electrically conductive polymer.

Specific examples of the matrix resin include an acrylic resin, an epoxy resin, and a polyester resin. Examples of antirust additives include a zinc powder and phosphorus iron.

A method for manufacturing a steel sheet overlap structure of the first embodiment will be described below.

The steel sheet overlap structure of the first embodiment can be manufactured via an antirust treatment process of forming the antirust layer 14 on the surface of the steel sheet 10 and a joining process of joining the steel sheet 10 and the steel sheet 12 via the antirust layer 14. The antirust layer 14 may be formed at least in a region where the steel sheet 10 and steel sheet 12 overlap and may be formed over the entire surface of the steel sheet 10. Further, the antirust layer may be formed on the surface of at least one steel sheet and may be formed on both opposing steel sheets. When the antirust layer is formed on both opposing steel sheets, the two steel sheets are joined by bringing the antirust layer formed on the surface of one steel sheet into contact with the antirust layer formed on the surface of the other steel sheet.

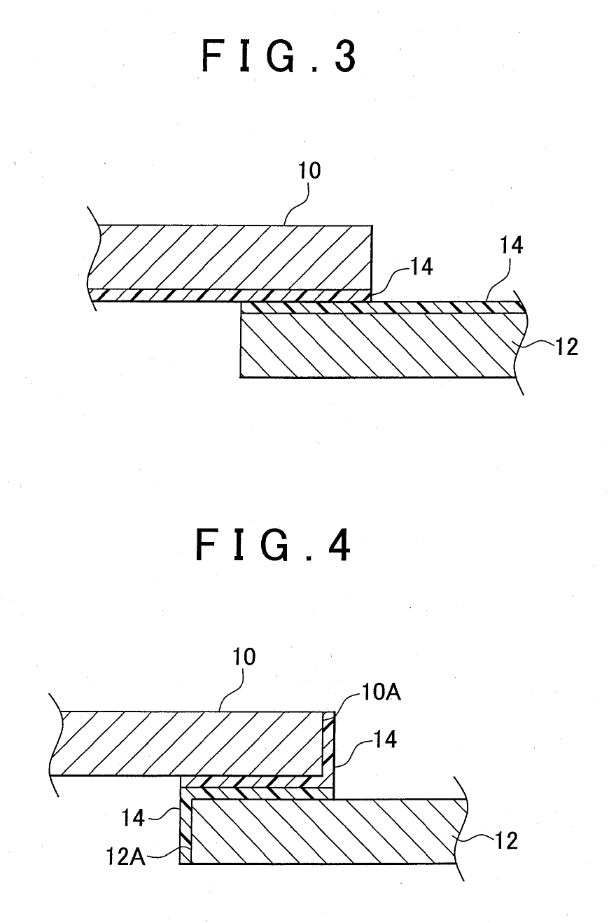

FIG. 3 is a cross-sectional view illustrating a periphery of a joint portion of a modification example of a steel sheet overlap structure of the first embodiment. In the present embodiment, the antirust layer 14 is formed on both the steel sheet 10 and the steel sheet 12. Where the steel sheet overlap structure has such a configuration, the antirust effect can be further increased.

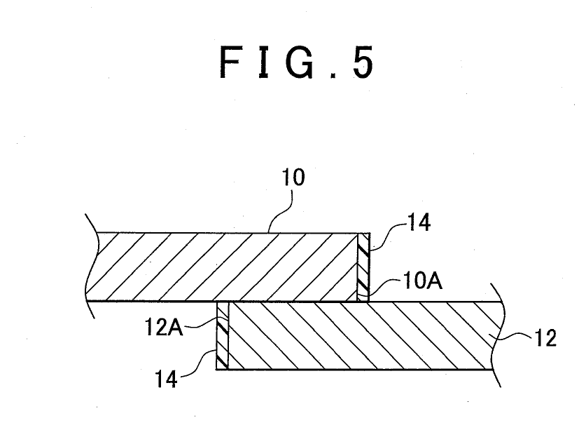

FIG. 4 is a cross-sectional view illustrating a periphery of a joint portion of another modification example of a steel sheet overlap structure of the first embodiment. In the present embodiment, the antirust layer 14 is provided to extend in the direction of both an end surface 10A of the steel sheet 10 and an end surface 12A of the steel sheet 12. Where the steel sheet overlap structure has such a configuration, the antirust effect can be further increased.

In the antirust treatment process, a coating film formed by coating the coating liquid including the components constituting the antirust layer 14 is dried and, if necessary, cured by heating. The components constituting the antirust layer 14 are described above. The coating film may be also formed by immersing the steel sheet into the coating liquid or by spray coating the coating liquid on the steel sheet.

When the steel sheet 10 and steel sheet 12 are joined by spot welding, a galvanized layer formed on the steel sheet surface can hinder the spot welding. In the related technology, where the amount of coated zinc is small, a sufficient antirust effect cannot be obtained. In the present embodiment, the antirust layer 14 including the electrically conductive polymer is provided between the joining surfaces of the steel sheet 10 and steel sheet 12. Therefore, a sufficient antirust effect can be demonstrated even when the amount of coated zinc is reduced to a degree such that it does not hinder the spot welding. Furthermore, when spot welding is performed, the antirust layer 14 is decomposed and removed by overheating. Therefore, the antirust layer 14 does not hinder the spot welding.

For example, in the case of an automobile body, the antirust process of the related technology is performed after the body (steel sheet overlap structure) is assembled. Therefore, zones into which a coating film or deposited material will not penetrate in the subsequent conversion film formation process and electrodeposition coating can appear in the periphery of the joint portion of the steel sheet. As a result, an antirust treatment has to be implemented with respect to the periphery of the joint portion with a body sealer, an undercoat, and a pouch wax. In addition, because the body sealer operation is performed manually, the finish state of the coating is deteriorated due dust and dirt introduced by people and quality of antirust treatment can become unstable. However, by performing the joining process of steel sheets after the antirust treatment process has been implemented with respect to the steel sheets, as in the present embodiment, it is possible to implement sufficient antirust processing with respect to the joint portion of steel sheets where coating or painting is difficult to perform. Therefore, the auxiliary antirust materials such as a sealer can be eliminated or the amount thereof can be greatly reduced and the cost and process duration required for the antirust treatment can be reduced. In addition, because the body sealer operation that is performed manually becomes unnecessary, the finished state of coating is improved and antirust quality is stabilized.

FIG. 5 is a cross-sectional view illustrating a joint portion of a steel sheet overlap structure of the second embodiment of the present invention. The steel sheet overlap structure of the second embodiment includes the steel sheet 10 and steel sheet 12 joined to each other and an antirust layer 14 provided on the end surface 10A of the steel sheet 10 and the end surface 12A of the steel sheet 12 in the joint portion.

By providing the antirust layer 14 on the end surface 10A of the steel sheet 10 and the end surface 12A of the steel sheet 12 in the joint portion, it is possible to prevent the occurrence of rust in the joint portion.

The steel sheet overlap structure of the second embodiment can be manufactured by an antirust treatment process of forming the antirust layer 14 on the end surface 10A of the steel sheet 10 and the end surface 12A of the steel sheet 12 and a joining process of joining the steel sheet 10 and the steel sheet 12 so that the end surface 10A and end surface 12A are located in the vicinity of the joining position of the steel sheet 10 and steel sheet 12. In the steel sheet overlap structure of the second embodiment, the antirust layer may be formed on the end surface of at least one steel sheet, but the antirust effect can be further increased by forming the antirust layer on the end surfaces of both sheets. Further, specific examples of constituent materials of the antirust layer, method for forming the antirust layer, and method for joining the sheet sheets in the second embodiment are identical to those of the first embodiment.

The present invention will be described below in greater details based on examples thereof, but the present invention is not limited to these examples.

A coating liquid for forming an antirust layer was prepared by adding a polyaniline to a clear coating material for an automobile manufactured by Kansai Paint (acrylic coating material, Kinol 200TW) at 2 wt. % based on a resin component in the coating material.

A sheet of SPC270D conforming to the JIS standard was used as a cold-rolled sheet for an automobile, and the coating liquid for forming an antirust layer that was obtained in the above-described manner was coated on the surface of the steel sheet with an applicator (draw bead) and dried for 20 min at 140° C. to form an antirust layer with a dry film thickness of 20 μm.

A sheet of SPC270D conforming to the JIS standard was placed as a cold-rolled sheet for an automobile on the antirust layer of the cold-rolled sheet for an automobile on which the antirust layer has been formed and spot welding was performed at a welding current of 5000 A, a pressure force of 588 N, and a number of conduction cycles of 33 to obtain an Evaluation Sample 1. An Evaluation Sample 2 was obtained in the same manner as the Evaluation Sample 1, except that no antirust layer was formed. When the spot welding was performed, no difference in spot weldability was observed between the Evaluation Samples 1 and 2, and spot weldability of the Evaluation Sample 1 was good.

A composite cycle test conforming to JIS K5621 was performed with respect to the Evaluation Samples 1 and 2. The state of rust on the periphery of the joint portion after a predetermined number of cycles was evaluated by observations after disjoining the sheets. The results demonstrated that in the Evaluation Sample 2, red rust appeared in part of the periphery of the joint portion after 30 cycles, and red rust appeared over the entire surface of the periphery of the joint portion after 60 cycles. Further, the periphery of the joint portion was lifted by the rust after 120 cycles. On the other hand, in the Evaluation Sample 1, red rust appeared in part of the periphery of the joint portion after 120 cycles.

While the invention has been described with reference to example embodiments thereof, it is to be understood that the invention is not limited to the described embodiments of constructions. On the other hand, the invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A steel sheet overlap structure, comprising:
a pair of joined steel sheets; and
an antirust layer which comprises an electrically conductive polymer, and which is provided between joining surfaces of the steel sheets.

2. A steel sheet overlap structure, comprising:
a pair of steel sheets joined in a joint portion; and
an antirust layer which comprises an electrically conductive polymer; and which is provided between a periphery of the joint portion and opposing surfaces of the pair of steel sheets.

3. The steel sheet overlap structure according to claim 1, wherein the antirust layer is provided to extend to an end surface of the steel sheets in a joint portion.

4. A steel sheet overlap structure comprising:
a pair of joined steel sheets; and
an antirust layer which comprises an electrically conductive polymer, and which is provided at an end surface of the steel sheets.

5. The steel sheet overlap structure according to claim 1, wherein the electrically conductive polymer is a polyaniline.

6. The steel sheet overlap structure according to claim 4, wherein the electrically conductive polymer is a polyaniline.

7. The steel sheet overlap structure according to claim 5, wherein the polyaniline is a polyaniline doped with a metal phosphate.

8. The steel sheet overlap structure according to claim 6 wherein the polyaniline is a polyaniline doped with a metal phosphate.

9. The steel sheet overlap structure according to claim 1, wherein in the antirust layer, the electrically conductive polymer forms a passive body on the steel sheets.

10. The steel sheet overlap structure according to claim 4, wherein in the antirust layer, the electrically conductive polymer forms a passive body on the steel sheets.

11. A steel sheet for a steel sheet overlap structure, comprising an antirust layer containing an electrically conductive polymer on the steel sheet.

12. The steel sheet according to claim 11, wherein in the antirust layer, the electrically conductive polymer forms a passive body on the steel sheets.

13. The steel sheet according to claim 11, wherein in the antirust layer, the electrically conductive polymer is a polyaniline.

14. The steel sheet according to claim 13, wherein in the antirust layer, the polyaniline is doped with a metal phosphate.

15. A method for manufacturing a steel sheet overlap structure, comprising:
an antirust treatment process of forming an antirust layer containing an electrically conducive polymer on at least one surface of a pair of steel sheets to be joined; and
a joining process of joining the pair of steel sheets via the antirust layer.

16. A method for manufacturing a steel sheet overlap structure, comprising:
an antirust treatment process of forming an antirust layer containing an electrically conducive polymer on an end surface of at least one steel sheet of a pair of steel sheets to be joined; and
a joining process of joining the pair of steel sheets so that the end surface where the antirust layer has been formed is located in the vicinity of a joining position of the pair of steel sheets.

17. The method for manufacturing a steel sheet overlap structure according to claim 15, wherein the electrically conductive polymer is a polyaniline.

18. The method for manufacturing a steel sheet overlap structure according to claim 17, wherein the polyaniline is a polyaniline doped with a metal phosphate.

19. The method for manufacturing a steel sheet overlap structure according to claim 16, wherein the electrically conductive polymer is a polyaniline.

20. The method for manufacturing a steel sheet overlap structure according to claim 19, wherein the polyaniline is a polyaniline doped with a metal phosphate.
